(19) United States
(12) Patent Application Publication
(10) Pub. No.: US 2024/0343332 A1
(43) Pub. Date: Oct. 17, 2024

(54) FOOTREST ASSEMBLY FOR A STRADDLE SEAT VEHICLE, STRADDLE-SEAT VEHICLE AND OUTER PART FOR FOOTREST ASSEMBLY

(71) Applicant: BOMBARDIER RECREATIONAL PRODUCTS INC., Valcourt (CA)

(72) Inventors: Bruno CYR, Shefford (CA); Mathieu COUTURE-PELLETIER, Bromont (CA); Etienne THIBAULT, Sherbrooke (CA)

(21) Appl. No.: 18/682,180

(22) PCT Filed: Aug. 9, 2022
(86) PCT No.: PCT/IB2022/057433

§ 371 Date: Feb. 8, 2024

Related U.S. Application Data
(60) Provisional application No. 63/231,522, filed on Aug. 10, 2021.

(51) Int. Cl. B62J 25/06; B62K 11/04

(52) U.S. Cl. CPC B62J 25/06; B62K 11/04

(57) ABSTRACT

A footrest assembly for a straddle-seat vehicle having a frame is disclosed. The footrest assembly includes a first part connectable to the frame, and a second part selectively connectable to the first part at at least two positions along a length of the first part. The second part has a footrest portion extending generally parallelly to the length of the first part. A combined length of the first and second parts changes in response to the second part being selectively moved from the first position to the second position. A straddle-seat vehicle and an outer part for a footrest assembly are also disclosed.

### CROSS-REFERENCE TO RELATED APPLICATION

The present application claims priority to U.S. Provisional Patent Application No. 63/231,522, filed Aug. 10, 2021 entitled “Footrest Assembly for a Straddle Seat Vehicle, Straddle-Seat Vehicle and Outer Part for Footrest Assembly”, which is incorporated by reference herein in its entirety.

### FIELD OF THE TECHNOLOGY

The present technology relates to footrest assemblies for straddle seat vehicles, straddle seat vehicles having footrest assemblies and outer parts for footrest assemblies.

### BACKGROUND

Wheeled straddle-seat vehicles are provided with driver footrest assemblies on each side of the vehicle vertically below the seat to support the feet of the driver.

A foot-actuated brake lever may be provided near one of the footrest assemblies and in straddle-seat vehicles with manual or semi-automatic transmissions, a foot-operated gear shift lever may also be provided near one of the footrest assemblies.

As a vehicle may be driven by different drivers and in various stances it could be desirable to provide footrest assemblies able to accommodate different sizes and/or preferences of straddle-seat vehicles, in particular for vehicles that may be operated while in a standing position.

### SUMMARY

It is an object of the present technology to ameliorate at least some of the inconveniences mentioned above.

According to an aspect of the present technology, there are provided footrest assemblies which provide laterally adjustable positions in order to accommodate different driver sizes and/or foot position preferences. The footrest assemblies are formed from a first part connected to and extending outward from the vehicle and a second part connected to the first part. The second part is selectively positionable at a plurality of positions laterally along the first part in order to provide laterally adjustable foot positions for the driver.

According to one aspect of the present technology, there is provided a footrest assembly for a straddle-seat vehicle having a frame. The footrest assembly includes a first part and a second part. The first part is connectable to the frame, and the second part is selectively connectable to the first part at at least two positions along a length of the first part. The second part has a footrest portion that extends generally parallelly to the length of the first part. A combined length of the first and second parts changes in response to the second part being selectively moved from the first position to the second position.

In some embodiments, a first distance extends between a first connecting portion of the first part adjacent to the frame and the footrest portion when the second part is at the first position, and a second distance extends between the first connecting portion of the first part adjacent to the frame and the footrest portion when the second part is at the second position. The second distance is greater than the first distance.

In some embodiments, the combined length of the first and second parts when the second part is at the first position is a first combined length, and the combined length of the first and second parts when the second part is at the second position is a second combined length. The second combined length is greater than the first combined length.

In some embodiments, the first part at least defines a first aperture and a second aperture, and the second part defines a third aperture. The footrest assembly further comprises a fastener. When the second part is connected to the first part at the first position, the fastener is received in the first and third apertures. When the first part is connected to the second part at the second position, the fastener is received in the second and third apertures.

In some embodiments, the at least two positions includes three positions. The first part defines a fourth aperture, and the second part can be positioned at a third position along a length of the first part. When the second part is connected to the first part at the third position, the fastener is received in the third and fourth apertures.

In some embodiments, the first part has at least a first engaging member and a second engaging member, and the second part has a third engaging member engageable to at least one of the first and second engaging members. When the second part is connected to the first part at the first position, the third engaging member engages the first engaging member. When the second part is connected to the first part at the second position, the third engaging member engages the second engaging member.

In some embodiments, the first part includes a beam-like portion extending along the length of the first part.

In some embodiments, the second part defines a receiving aperture configured to at least partially receive the beam-like portion.

In some embodiments, the second part has a second connecting portion configured to engage with the beam-like portion.

In some embodiments, the footrest portion has traction enhancing members extending from a top surface of the second part.

In some embodiments, the footrest portion has a side member disposed on an outward end of the outer part and extending upwardly from the top surface.

In some embodiments, the first part is an inner part, and the second part is an outer part.

According to another aspect of the present technology, there is provided a straddle-seat vehicle including a frame, a motor, at least one front wheel and at least one rear wheel, a straddle-seat and first and second footrest assemblies. The frame defines a longitudinal center plane. The motor is supported by the frame. The at least one front and rear wheels is supported by the frame and is operatively connected to the motor. The straddle-seat supported by the frame. The first footrest assembly is disposed on a first side of the longitudinal center plane, and the second footrest assembly disposed on a second side of the longitudinal center plane. Each one of the first and second footrest assemblies includes a first part and a second part. The first part is connected to the frame, and a length of the first part extends generally transversally to the longitudinal center plane. The second part has a footrest portion, and is selectively connectable to the first part at at least two positions along the length of the first part. The second part is selectively positionable at different distances from the longitudinal center plane.

In some embodiments, a first distance extends between a first connecting portion of the first part adjacent to the frame and the footrest portion when the second part is at the first position, and a second distance extends between the first connecting portion of the first part adjacent to the frame and the footrest portion when the second part is at the second position. The second distance is greater than the first distance.

In some embodiments, a combined length of the first and second parts changes in response to the second part being selectively moved from the first position to the second position.

In some embodiments, when the second part is connected to the first part at the first position, the first and second parts have a first combined length, and when the second part is connected to the first part at the second position, the first and second parts have a second combined length. The second combined length is greater than the first combined length.

In some embodiments, the first part at least defines a first aperture and a second aperture, and the second part defines a third aperture. The footrest assembly further includes a fastener. When the second part is connected to the first part at the first position, the fastener is received in the first and third apertures; and when the first part is connected to the second part at the second position, the fastener is received in the second and third apertures.

In some embodiments, the at least two positions includes three positions. The first part defines a fourth aperture, and the second part can be positioned at a third position along a length of the first part. When the second part is connected to the first part at the third position, the fastener is received in the third and fourth apertures.

In some embodiments, the first part has at least a first engaging member and a second engaging member. The second part has a third engaging member engageable to one of the first and second engaging members. When the second part is connected to the first part at the first position, the third engaging member engages the first engaging member, and when the second part is connected to the first part at the second position, the third engaging member engages the second engaging member.

In some embodiments, the first part includes a beam-like portion extending along the length of the first part and outwardly from the frame.

In some embodiments, the second part defines a receiving aperture configured to at least partially receive the beam-like portion.

In some embodiments, the second part has a second connecting portion configured to engage with the beam-like portion.

According to another aspect of the present technology, there is provided an outer part for a footrest assembly. The outer part is selectively connectable to an inner part connected to a frame of a vehicle. The outer part includes a footrest portion defined on a top surface of the outer part and a connecting portion defined on an inner side of the outer part, the connecting portion defining an aperture configured to receive a fastener therethrough and the connecting portion being selectively connectable to the inner part at at least two positions along a length of the inner part.

In some embodiments, the outer part defines a receiving aperture configured to receive at least a portion of the inner part.

In some embodiments, the outer part defines an engaging member engageable with at least one engaging member of the inner part.

In some embodiments, the footrest portion has traction enhancing members extending from the top surface of the outer part.

In some embodiments, the footrest portion has a side member disposed on a second lateral side of the outer part and extending upwardly from the top surface.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

For the purpose of this application, terms related to spatial orientation such as downwardly, rearwardly, forward, front, rear, left, right, above and below are as they would normally be understood by a driver of the vehicle sitting thereon in an upright position with the vehicle in a straight ahead orientation (i.e. not steered left or right), and in an upright position (i.e. not tilted).

Implementations of the present vehicle each have at least one of the above-mentioned object and/or aspects, but do not necessarily have all of them. It should be understood that some aspects of the present vehicle that have resulted from attempting to attain the above-mentioned object may not satisfy this object and/or may satisfy other objects not specifically recited herein.

Additional and/or alternative features, aspects, and advantages of implementations of the present vehicle will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, rear, left side of a three-wheel straddle-type vehicle;

FIG. 2 is atop plan view of the vehicle of FIG. 1;

FIG. 3 is a top plan view of a right footrest assembly of the vehicle of FIG. 1;

FIG. 4 is a perspective view taken from a top, rear, right side of a left footrest assembly of the vehicle of FIG. 1, the footrest assembly including a rail mount, a clamping member, an inner part and an outer part, wherein the outer part is connected to the inner part at an outer position;

FIG. 5 is a top plan view of the left footrest assembly of FIG. 4;

FIG. 6 is a cross-sectional view of the left footrest assembly of FIG. 4 taken across the line 6-6 of FIG. 5;

FIG. 7 is a top plan view of the left footrest assembly of FIG. 4, wherein the outer part is connected to the inner part at an inner position;

FIG. 8 is a cross-sectional view of the left footrest assembly of FIG. 4 taken across the line 8-8 of FIG. 7;

FIG. 9 is a perspective view taken from a rear side of the inner part of the left footrest assembly of FIG. 5;

FIG. 10 is a top plan view of the inner part of FIG. 9.

FIG. 11 is a perspective view taken from a top, rear, right side of the outer part of the left footrest assembly of FIG. 5; and

FIG. 12 is a top plan view of the outer part of FIG. 11.

### DETAILED DESCRIPTION

The present description is provided with respect to a three-wheel straddle-type vehicle, which is a non-leaning straddle-seat vehicle 10. However, it should be understood that other types of non-leaning straddle-type vehicles such as, for example, three- or four-wheel all-terrain vehicles are also contemplated. It is further understood that the present technology could be used with other kinds of straddle-type vehicles.

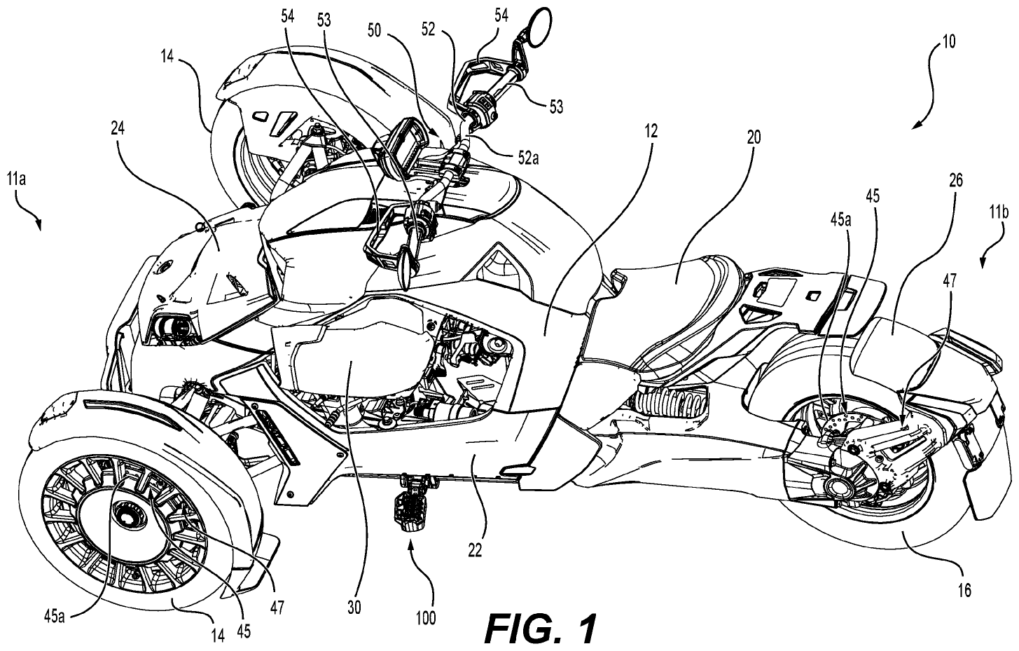

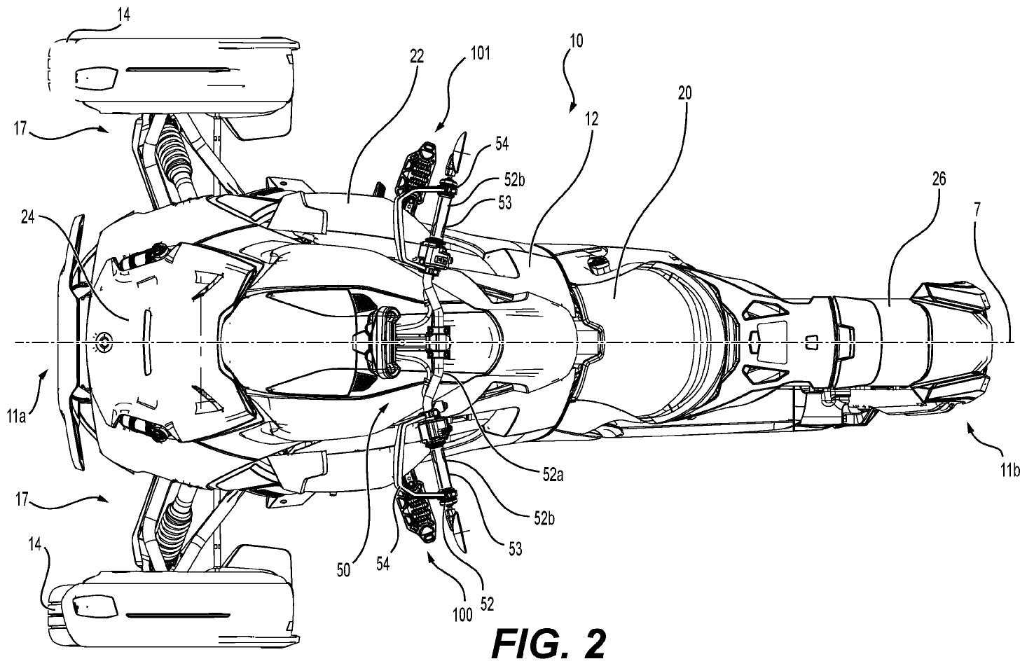

With reference to FIGS. 1 and 2, a vehicle 10 has a front portion 11a and a rear portion 11b defined consistently with the forward travel direction of the vehicle 10. The vehicle 10 has a frame 12 which defines a longitudinal center plane 7.

The vehicle 10 is a three-wheel vehicle 10 including left and right front wheels 14 and a single rear wheel 16. It is however contemplated that the vehicle 10 could have more than one rear wheel 16 and/or a single front wheel 14. The left and right front wheels 14 and the rear wheel 16 each have a tire secured thereto. The front wheels 14 are equally offset from the longitudinal center plane 7 in the lateral direction, whereas the rear wheel 16 is centered with the longitudinal center plane 7.

As can be seen in FIG. 2, each front wheel 14 is mounted to the frame 12 of the vehicle 10 via a front suspension assembly 17. In the illustrated implementation, the front suspension assembly 17 is a double A-arm type suspension, also known as a double wishbone suspension. It is contemplated that other types of suspensions, such as a MacPherson strut or a swing arm assembly, could be used. The rear wheel 16 is connected to the frame 12 by a rear suspension assembly (not shown).

The vehicle 10 has a straddle seat 20 disposed along the longitudinal center plane 7 and supported by the frame 12. The straddle seat 20, adapted to accommodate a single adult-sized rider. It is contemplated that in some embodiments, the straddle seat 20 could be configured to accommodate two adult-sized riders (a driver and a passenger).

The frame 12 supports a motor 30 (shown in FIG. 1) located longitudinally forward of the straddle seat 20 and longitudinally rearward of the front wheels 14. In the illustrated implementation of the vehicle 10, the motor 30 is in the form of an internal combustion engine. It is however contemplated that the motor 30 could be other than an internal combustion engine. For example, the motor 30 could be an electric motor, a hybrid or the like. The motor 30 will be referred to hereinafter as engine 30 for convenience. The engine 30 is an inline, three-cylinder, four-stroke, internal combustion engine in the illustrated implementation of the vehicle 10, but it is contemplated that other types of internal combustion engines could be used. The engine 30 is operatively connected to the rear wheel 16 to drive the rear wheel 16. It is contemplated that the engine 30 could be operatively connected to the front wheels 14 instead of, or in addition to, the rear wheel 16.

Still referring to FIGS. 1 and 2, fairings 22 are connected to the frame 12 to enclose and protect the internal components of the three-wheel vehicle 10 such as the engine 30. The fairings 22 include a hood 24 disposed at the front of the vehicle 10 between the front wheels 14. The fairings 22 also include a rear deflector 26 disposed over the rear wheel 16 to prevent dirt and water from being projected upward by the wheel 16 while it is rolling.

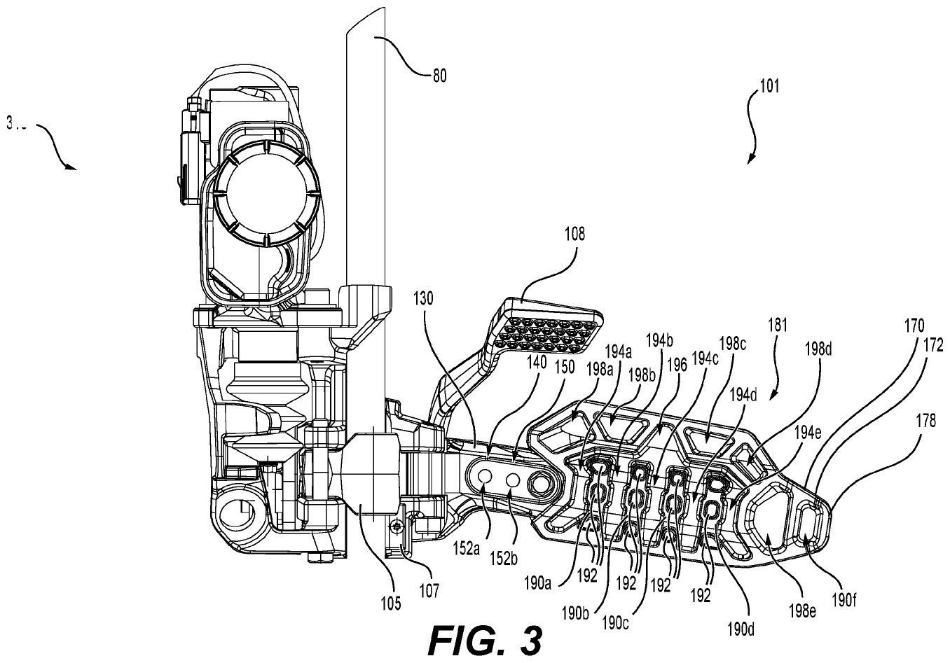

With reference to FIG. 1, each of the two front wheels 14 and the rear wheel 16 is provided with a brake 45. The brakes 45 of the three wheels 14, 16 form part of a brake assembly 47. Each brake 45 is a disc-type brake mounted onto a hub of the respective wheel 14 or 16. Other types of brakes are contemplated. Each brake 45 includes a rotor 45a mounted onto the wheel hub and a stationary caliper (not shown) straddling the rotor 45a. The brake pads (not shown) are mounted to the caliper so as to be disposed between the rotor 45a and the caliper on either side of the rotor 45a. When hydraulic pressure is applied to a piston (not shown) of the caliper 45b, the brake pads squeeze the rotor 45a which, through friction, brakes the wheel 14 or 16. The brake pads are connected to a hydraulic actuation system 310 (FIG. 3).

A steering assembly 50 is disposed forwardly of the straddle seat 20 to allow a driver to steer the two front wheels 14. The steering assembly 50 includes a handlebar 52 connected to a steering column (not shown). The steering column is connected to the front wheels 14 via steering linkages (not shown) such that turning the handlebar 52 turns the steering column which, through the steering linkages, turns the wheels 14. In the illustrated implementation of the vehicle 10, the steering assembly 50 includes a power steering unit (not shown) to facilitate steering of the vehicle 10. It is contemplated that the power steering unit could be omitted.

The handlebar 52 includes a central portion 52a connected to the upper end of the steering column. The central portion 52a extends upwardly and leftwardly to a left handle 52b, and upwardly and rightwardly to a right handle 52b. A left hand grip 53 and a right hand grip 53 are placed respectively around the left and right handles 52b. A left hand guard 54 is connected to the handlebar 52, on either side of the left hand grip 53, and a right hand guard 54 is connected to the handlebar 52, on either side of the right hand grip 53. It is contemplated that in some embodiments, a clutch actuator could be connected to the handlebar 52 near the left hand grip 53. It is also contemplated that a hand operated brake actuator could also be connected to the handlebar 52 near one of the hand grips 53. Such a hand operated brake actuator could be operatively connected to the brakes 45 provided on each of, or one of, the two front wheels 14 and the rear wheel 16. In the illustrated implementation of the vehicle 10, the position of the handles 52b and the grips 53 is fixed. It is contemplated that the handlebar 52 could be adjustable such that the handles 52b and grip 53 may be repositioned, for example, in accordance with the driver's size and preferences.

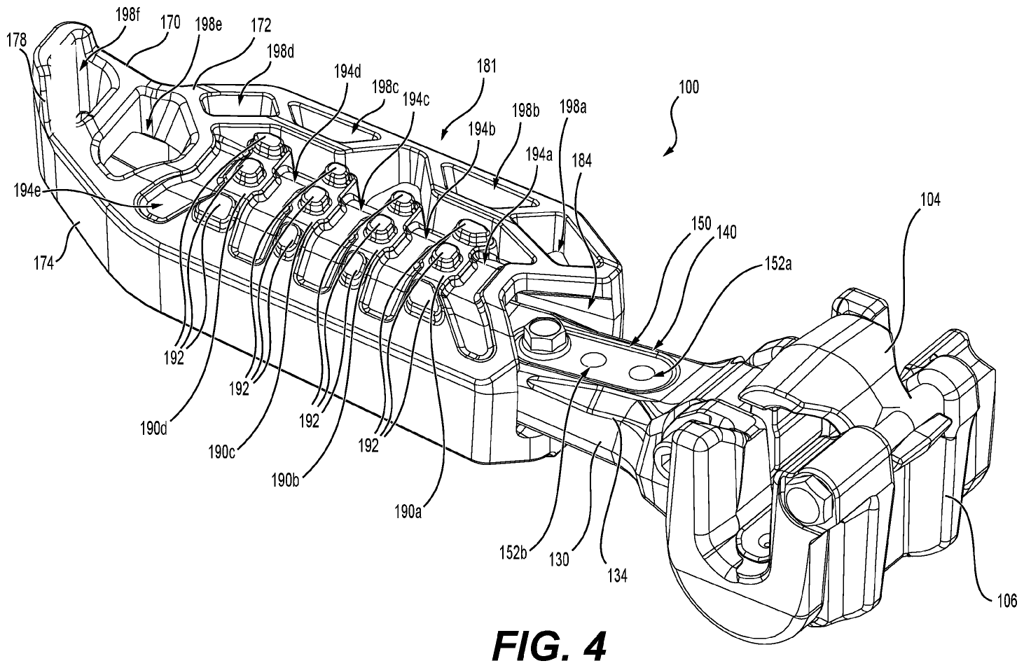

The vehicle 10 includes a left footrest assembly 100 that is disposed on a left side of the center plane 7 (FIG. 4), and a right footrest assembly 101 that is disposed on a right side of the center plane 7 (FIG. 3). The left and right footrest assemblies 100, 101 are vertically lower than the straddle seat 20 to support the driver's feet.

Referring to FIG. 4, the left footrest assembly 100 includes a clamping member 104 and a rail mount 106. The left footrest assembly 100 is connected to the frame 12, more precisely to a rail (not shown) of the frame 12, by the clamping member 104 and the rail mount 106. The left footrest assembly 100 will be described in more detail below.

Referring to FIG. 3, the right footrest assembly 101 includes a clamping member 105, a rail mount 107 and a brake lever 108. The brake lever 108, which is mounted to the rail mount 107, is operatively connected to the hydraulic brake actuation system 310, and thereby to the brake assembly 47, for actuating the brakes 45. The right footrest assembly 101 is connected to the frame 12, more precisely to a rail 80 of the frame 12, by the clamping member 105 and the rail mount 107. The right footrest assembly 101 will be described in more detail below.

The clamping members 104, 105 and the rail mounts 106, 107, which enable the left and right footrest assemblies 100, 101 to be moved longitudinally along the rails 80, are similar to the ones disclosed in United States Patent Publication No. 2019/0315429, published Oct. 17, 2019, the entirety of which is incorporated herein by reference. It is contemplated that in some embodiments, the clamping members 104, 105 and the rail mounts 106, 107 could be omitted, such that the left and right footrest assemblies 100, 101 could be configured to connect to the frame 12 of the vehicle 10 without the clamping members 104, 105 and the rail mounts 106, 107.

Additional portions of the left and right footrest assemblies 100, 101 will now be described. As the left and right footrest assemblies 100, 101 are mirror images of one another, only the left footrest assembly 100 will be described in detail herewith.

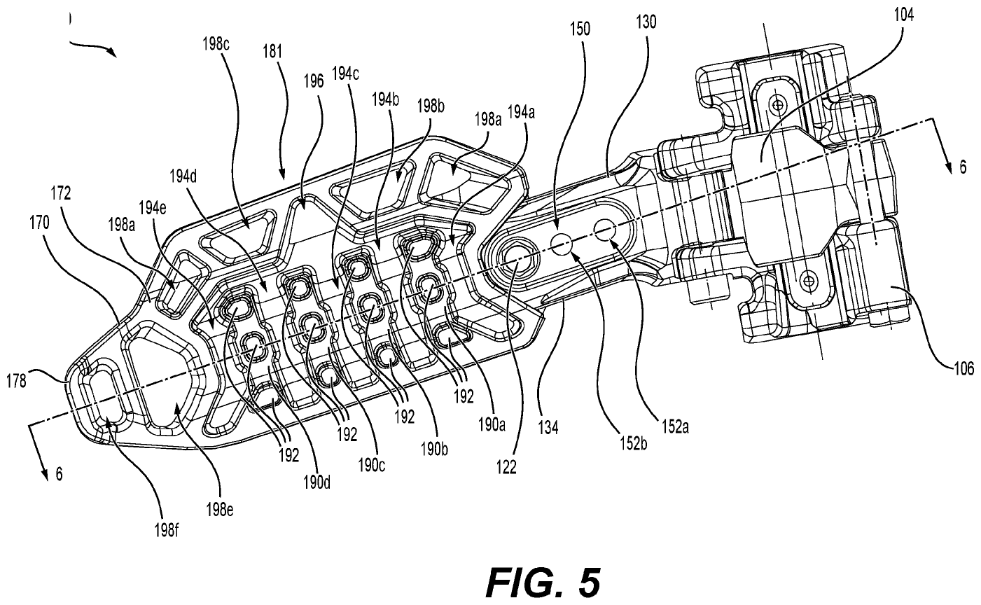

Referring to FIGS. 4 to 8, the left footrest assembly 100 includes an inner part 130 that is connectable to the frame 12, an outer part 170 that is selectively connectable to the inner part 130 and a fastener 122. The fastener 122 is a bolt. It is contemplated, however, that the fastener 122 could be another selectively removable fastener including connecting pins and studs. It is also contemplated that the fastener 122 could be in the form of a clamp, clip or other means of selectively connecting the inner and outer parts 130, 170 As will be described in greater detail below, it is contemplated that in some embodiments, the fastener 122 could be omitted.

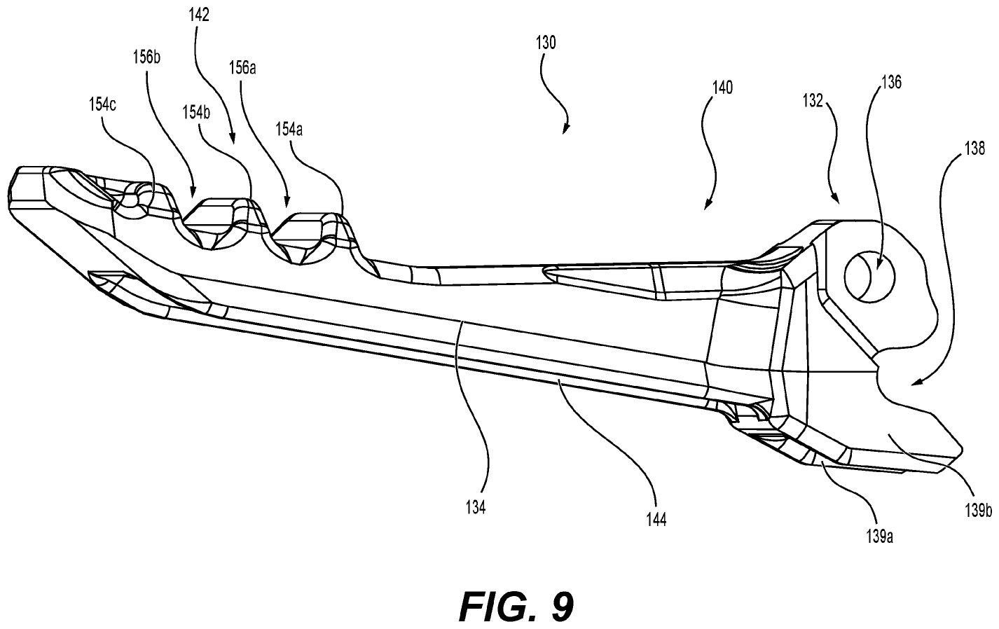

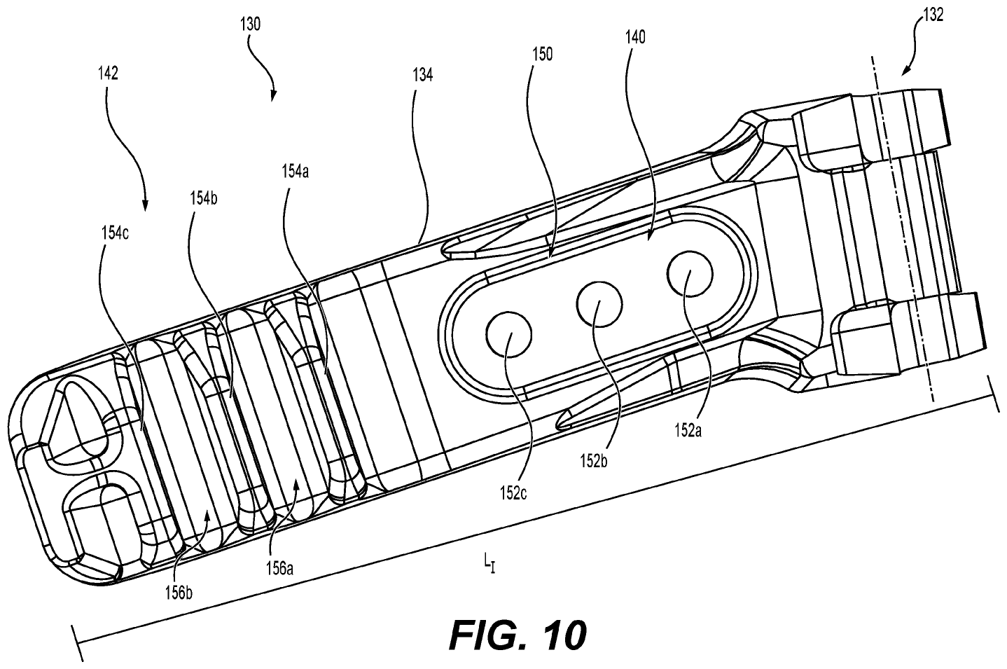

Referring to FIGS. 9 and 10, the inner part 130 has a connecting portion 132 which connects to the rail mount 106. The inner part 130 also includes a beam-like portion 134 connected to and extending generally laterally outward from the connecting portion 132. The beam-like portion 134 of the left footrest assembly 100 extends leftward and slightly rearward from the vehicle 10. The beam-like portion 134 of the right footrest assembly 101 extends rightward and slightly reward from the vehicle 10. The exact angle at which the beam-like portions 134 extend from the vehicle 10 could vary in different embodiments. The inner part 130, extending outwardly from the frame 12 and generally transversally from the center plane 7, has a length L_{I} that extends from an inner surface of the connecting portion 132 to an outer surface of the inner part 130 (FIG. 10).

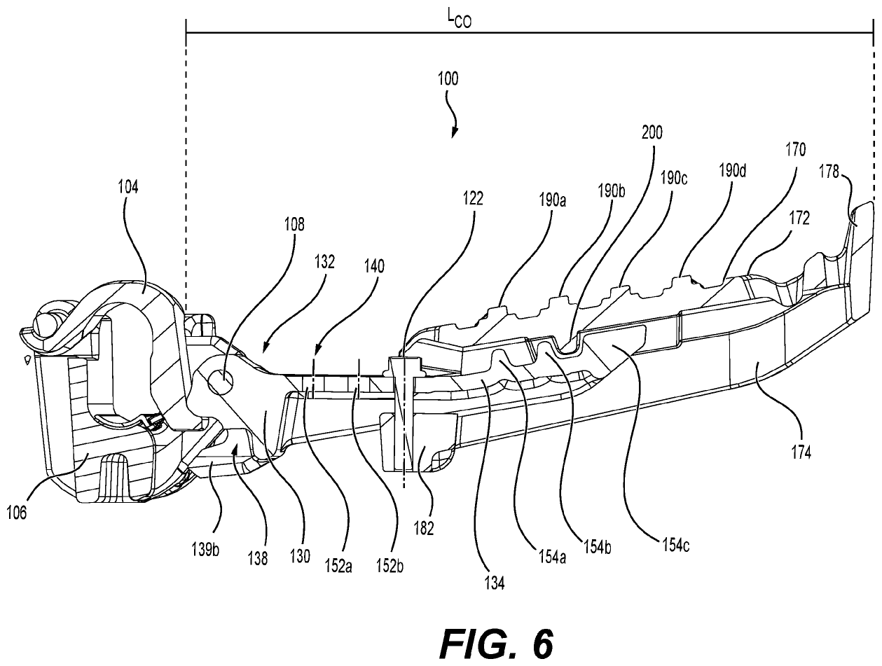

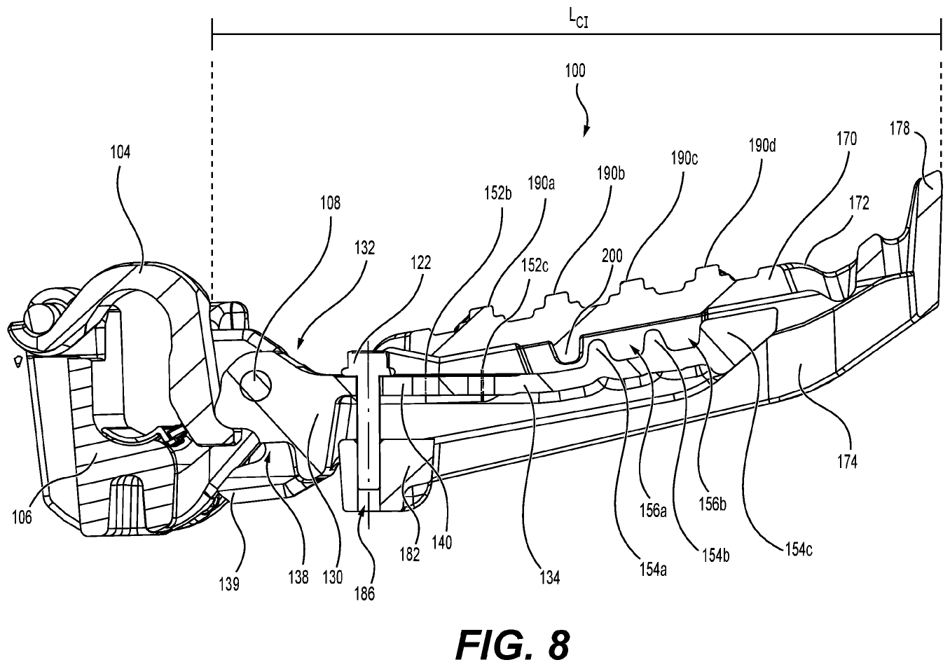

The connecting portion 132, which is configured to connect to the rail mount 106, defines an aperture 136 configured to receive a fastener 108 (FIGS. 6 and 8) therein. To connect the inner part 130 to the rail mount 106, the fastener 108 is received in apertures defined in the rail mount 106 and the aperture 136. The connecting portion 132 also defines a recess 138 vertically below the aperture 136. The recess 138 is configured to receive a portion of the clamping member 104 therein. The connecting portion 132 also has a pair of laterally spaced projections 139a, 139b configured to engage with the rail mount 106. It is understood that in some embodiments, the connecting portion 132 of the inner part 130 could be configured to connect to the frame 12 of the vehicle 10 without requiring the rail mount 106.

The beam-like portion 134, which extends along the length L_{I} of the inner part 130 and thus outwardly from the frame 12, is skewed with respect to the connecting portion 132 (i.e. the beam-like portion 134 does not extend perpendicularly to the connecting portion 132 as is mentioned above). The beam-like portion 134 has a generally flat upper surface 140 and an upwardly inclined upper surface 142. The beam-like portion 134 also has an upwardly inclined lower surface 144. The beam-like portion 134 defines an elliptical recess 150 on the generally flat upper surface 140. Within the elliptical recess 150, the inner part 130 defines an inner aperture 152a, an intermediate aperture 152b and an outer aperture 152c where the inner aperture 152a is closest to the frame 12, and the outer aperture 152c is furthest from the frame 12. The inner, intermediate and outward apertures 152a, 152b, 152c are longitudinally spaced along the length L_{I}. It is contemplated that in other embodiments, there could be more or less than three apertures. It is also contemplated that the spacing between the apertures 152a, 152b, 152c could vary. The inner, intermediate and outer apertures 152a, 152b, 152c are through apertures and are configured to receive the fastener 122 therethrough.

The surface 142 includes three engaging members 154a, 154b, 154c that extend upwardly from the inclined upper surface 142. An intermediate channel 156a is defined between the engaging members 154a, 154b and an outer channel 156b is defined between the engaging members 154b, 154c. Use of the engaging members 154a, 154b, 154c will be described in more detail below.

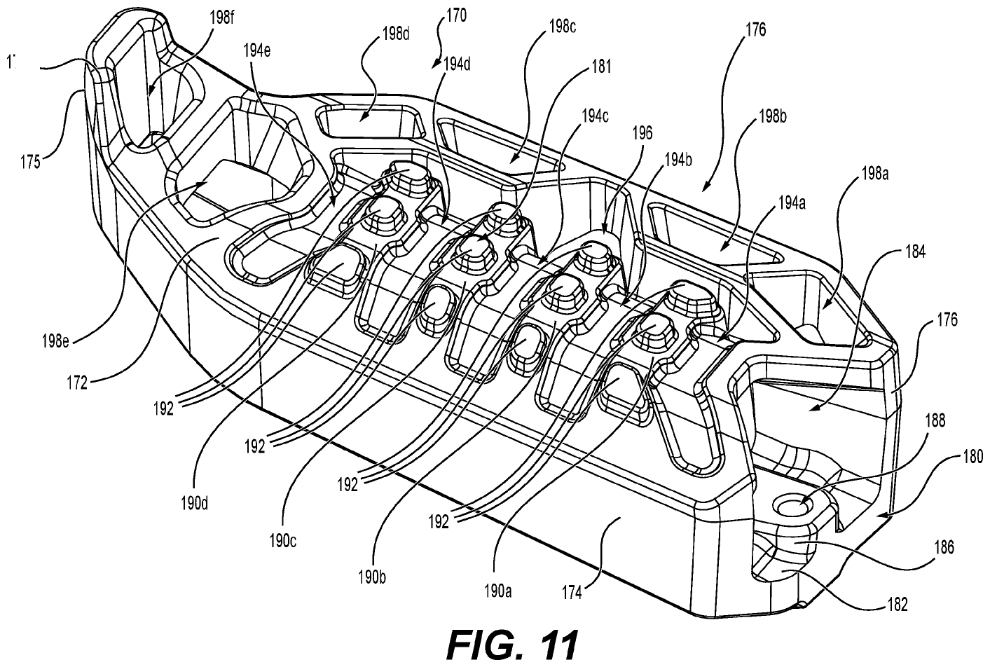

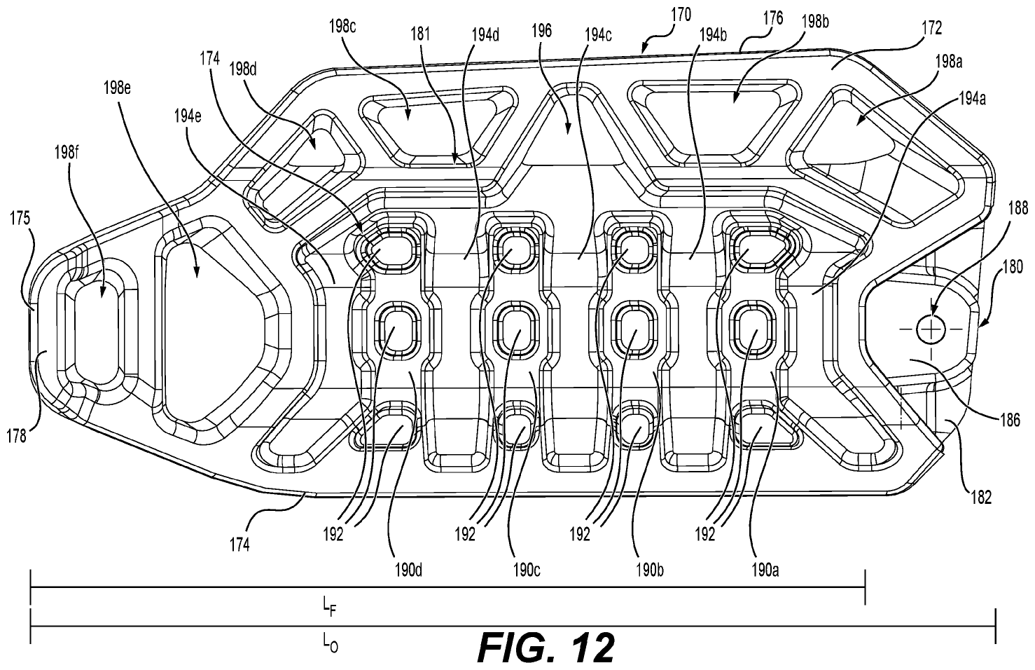

Referring to FIGS. 11 and 12, the outer part 170 has an elongate body that has a length L_{O} which extends generally parallelly to the length L_{I} when the outer part 170 is connected to the inner part 130. The outer part 170 has a top surface 172 from which a rear wall 174, outer side wall 175 and a front wall 176 extend generally downwardly. The outer side wall 175 also extends upwardly. As will be described in greater detail below, the outer part 170 has a ring-like connecting portion 180, which includes a lower wall 182, extending laterally outwardly from an inner side of the outer part 170. The outer part 170 also has a footrest portion 181 on the top surface 172 of the outer part 170.

At the connecting portion 180, the front and rear walls 174, 176 are connected by the lower wall 182, such that the connecting portion 180, and thus the outer part 170, defines a receiving aperture 184 on the inner side of the outer part 170 (i.e. in the ring-like portion 180). The lower wall 182 only extends below and outwardly along a small portion of a length of the top surface 172. In some embodiments, the lower wall 182 could extend laterally along an entirety of the outer part 170. As will be described in greater detail below, the receiving aperture 184 is configured to receive a portion of the inner part 130 therein. The connecting portion 180 has a lower engaging portion 186 extending from the lower wall 182. The outer part 170 defines an aperture 188 in the connecting portion 180. More precisely, the aperture 188, which is configured to receive the fastener 122 therethrough, is defined in the lower engaging portion 186 and the lower wall 182. It is contemplated that in some embodiments, the aperture 188 could be defined elsewhere in the outer part 170, for instance on a top surface thereof.

The footrest portion 181 has a length LF. When the outer part 170 is connected to the inner part 130, the length LF extends generally parallelly to the length L_{I}, and thus outwardly from the frame 12, and generally transversally to the center plane 7.

Still referring to FIGS. 11 and 12, the footrest portion 181 has four, laterally spaced, longitudinal segments 190a, 190b, 190c, 190d. It is contemplated that in other embodiments, there could be more or fewer than four longitudinal segments. It is also contemplated that in some embodiments, the shape of the segments 190a, 190b, 190c, 190d could vary. For instance, the segments 190a, 190b, 190c, 190d could be triangular segments. Each one of the four longitudinal segments 190a, 190b, 190c, 190d has three traction enhancing members 192 projecting upwardly therefrom. In some embodiments, there could be more or fewer than three traction enhancing members 192. In other embodiments, the size and/or shape of the traction enhancing members 192 could vary. The traction enhancing members 192 can aid in maintaining traction of a foot of the driver with the footrest assembly 100. The footrest portion 181 further defines five channels 194a, 194b, 194c, 194d, 194e on either side of the longitudinal segments 190a, 190b, 190c, 190d. The channels 194a, 194b, 194c, 194d, 194e converge to a triangular aperture 196. The footrest portion 181 further defines six apertures 198a, 198b, 198c, 198d, 198e, 198f. It is contemplated that in some embodiments, there could be more or fewer than six apertures. The triangular aperture 196 and the apertures 198a, 198b, 198c, 198d, 198e, 198f can help drain fluids and debris such as water and/or mud from the footrest portion 181. A side member 178 extends upwardly from the outer side of the footrest portion 181, and thus from the outer part 170, along with the outer side wall 175. The side member 178 offers a lateral abutting surface to a foot of the driver of the vehicle 10. It is contemplated that in some embodiments, the footrest portion 181 could be a generally flat surface.

The outer part 170 also has a lower engaging member 200 (shown in FIGS. 6 and 8) projecting downwardly from the footrest portion 181. As will be described in greater detail below, the lower engaging member 200 is configured to be receivable in the intermediate and outer channels 156a, 156b. As the lower wall 182 does not extend laterally below the footrest portion 181, the lower engaging member 200 is accessible from bottom side of the outer part 170.

The outer part 170 is connectable to the inner part 130 at an inward position, an intermediate position and an outward position. Moving the outer part from one position to another changes the distance between the outer part 170 and the frame 12, and thus also changes the distance between the outer part 170 and the center plane 7.

Referring to FIGS. 8 and 9, when the outer part 170 is connected to the inner part 130 at the inward position, a portion of the beam-like portion 134 is received in the receiving aperture 184 such that the aperture 182 is aligned with the inner aperture 152a. In the present embodiment, this coincides with when the lower engaging portion 186 engages the inner part 130, and when the lower engageable member 200 engages the engaging member 154a. The fastener 122 is inserted and fastened through the inner aperture 152a and the aperture 182, thereby connecting the outer part 170 to the inner part 130. The engagement between the lower engageable member 200 and the engaging member 154a aids in providing stability to the left footrest assembly 100. A combined length of the inner part 130 and the outer part 170 when the outer part 170 is at the inner position is length L_{CI}(FIG. 8).

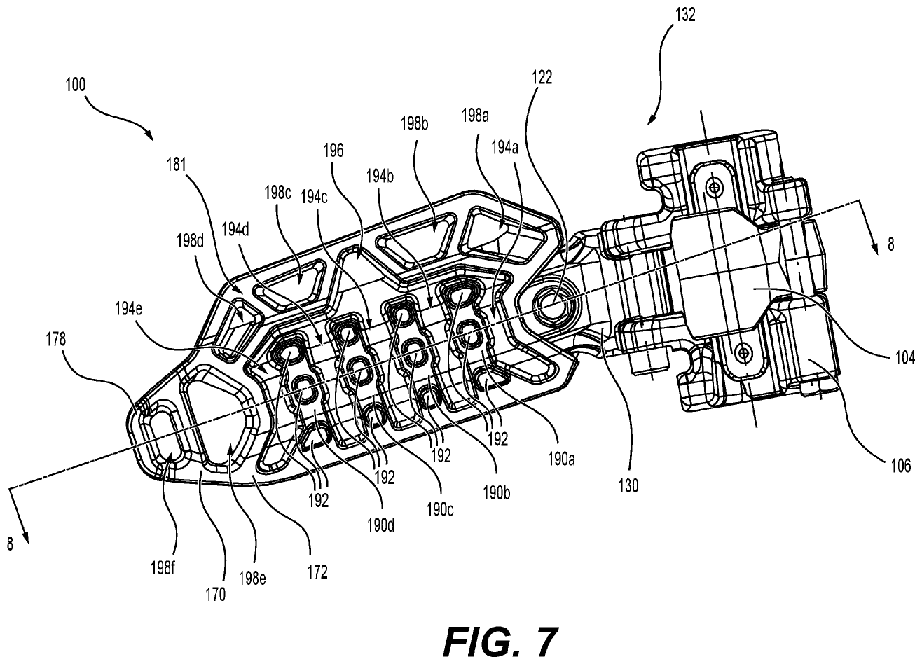

Referring to FIGS. 6 and 7, the outer part 170 can be repositioned to move the footrest portion 181 further outwardly from the frame 12. Starting with the footrest assembly 100 in the inward position, this can be done by removing the fastener 122 from inner aperture 152a and the aperture 182. Then, the outer part 170 is moved until the aperture 182 of the outer part 170 is aligned with the outer aperture 152c. The outer part 170 being open-ended from the bottom (i.e. the lower wall 182 not extending along the entirety of the outer part 170) facilitates the movement of the inner part 130 within the outer part 170. As mentioned above, it is contemplated that in some embodiments, the outer part 170 could be closed-ended from the bottom and could define a cavity in which the inner part 130 is inserted. When the aperture 182 is aligned with the outer aperture 152c, the lower engaging member 200 is received in the outer channel 156b, and engages with the engaging members 154b, 154c. The fastener 122 is inserted and fastened through the outer aperture 152a and the aperture 182, thereby connecting the outer part 170 to the inner part 130 in the outer position. The engagement between the lower engageable member 200 and the engaging members 154b, 154c aids in providing stability to the left footrest assembly 100. A combined length of the inner part 130 and the outer part 170 when the outer part is at the outer position is length L_{CO}. The length L_{CO} is greater than length L_{CI}, selectively providing a wider stance between the left and right footrest assemblies 100, 101. It will be appreciated that a wider stance may be more comfortable and/or provide greater stability for taller driver.

While not separately illustrated in the Figures, it should be understood that the outer part 170 could also be positioned such that the aperture 182 is aligned with the intermediate aperture 152b in order to arrange the footrest assembly 100 in the intermediate position. As mentioned above, selectively moving the outer part 170 at different positions changes the distance between the outer part 170 and the center plane 7. Embodiments with additional positions are also contemplated.

Modifications and improvements to the above-described implementations of the present vehicle may become apparent to those skilled in the art. The foregoing description is intended to be exemplary rather than limiting. The scope of the present technology is therefore intended to be limited solely by the scope of the appended claims.

What is claimed is:

1. A footrest assembly for a straddle-seat vehicle having a frame, the footrest assembly comprising:
a first part connectable to the frame; and
a second part being selectively connectable to the first part at at least two positions along a length of the first part, the second part having a footrest portion extending generally parallelly to the length of the first part; and
a combined length of the first and second parts changes in response to the second part being selectively moved from the first position to the second position.

2. The footrest assembly of claim 1, wherein:
a first distance extends between a first connecting portion of the first part adjacent to the frame and the footrest portion when the second part is at the first position;
a second distance extends between the first connecting portion of the first part adjacent to the frame and the footrest portion when the second part is at the second position; and
the second distance is greater than the first distance.

3. The footrest assembly of claim 1, wherein:
the combined length of the first and second parts when the second part is at the first position is a first combined length;
the combined length of the first and second parts when the second part is at the second position is a second combined length; and
the second combined length is greater than the first combined length.

4. The footrest assembly of claim 1, wherein:
the first part at least defines a first aperture and a second aperture;
the second part defines a third aperture;
the footrest assembly further comprises a fastener;
when the second part is connected to the first part at the first position, the fastener is received in the first and third apertures; and
when the first part is connected to the second part at the second position, the fastener is received in the second and third apertures.

5. The footrest assembly of claim 4, wherein:
the at least two positions include three positions,
the first part defines a fourth aperture, and the second part can be positioned at a third position along a length of the first part, and
when the second part is connected to the first part at the third position, the fastener is received in the third and fourth apertures.

6. The footrest assembly of claim 1, wherein:
the first part has at least a first engaging member and a second engaging member;
the second part has a third engaging member engageable to at least one of the first and second engaging members;
when the second part is connected to the first part at the first position, the third engaging member engages the first engaging member; and
when the second part is connected to the first part at the second position, the third engaging member engages the second engaging member.

7. The footrest assembly of claim 1, wherein the first part includes a beam-like portion extending along the length of the first part.

8. The footrest assembly of claim 7, wherein the second part defines a receiving aperture configured to at least partially receive the beam-like portion.

9. The footrest assembly of claim 7, wherein the second part has a second connecting portion configured to engage with the beam-like portion.

10. The footrest assembly of claim 1, wherein the footrest portion has traction enhancing members extending from a top surface of the second part.

11. The footrest assembly of claim 1, wherein the footrest portion has a side member disposed on an outward end of the outer part and extending upwardly from the top surface.

12. The footrest assembly of claim 1, wherein the first part is an inner part, and the second part is an outer part.

13. A straddle-seat vehicle comprising:
a frame defining a longitudinal center plane;
a motor supported by the frame;
at least one front wheel and at least one rear wheel, the at least one front and rear wheels being supported by the frame and being operatively connected to the motor;
a straddle-seat supported by the frame;
a first footrest assembly disposed on a first side of the longitudinal center plane; and
a second footrest assembly disposed on a second side of the longitudinal center plane,
each one of the first and second footrest assemblies comprising:
a first part connected to the frame, a length of the first part extending generally transversally to the longitudinal center plane; and
a second part having a footrest portion, the second part being selectively connectable to the first part at at least two positions along the length of the first part,
the second part being selectively positionable at different distances from the longitudinal center plane.

14. The straddle-seat vehicle of claim 13, wherein:
a first distance extends between a first connecting portion of the first part adjacent to the frame and the footrest portion when the second part is at the first position;
a second distance extends between the first connecting portion of the first part adjacent to the frame and the footrest portion when the second part is at the second position; and
the second distance is greater than the first distance.

15. The straddle-seat vehicle of claim 13, wherein:
a combined length of the first and second parts changes in response to the second part being selectively moved from the first position to the second position.

16. The straddle-seat vehicle of claim 15, wherein:
when the second part is connected to the first part at the first position, the first and second parts have a first combined length;
when the second part is connected to the first part at the second position, the first and second parts have a second combined length; and
the second combined length is greater than the first combined length.

17. The straddle-seat vehicle of claim 13, wherein:
the first part at least defines a first aperture and a second aperture;
the second part defines a third aperture;
the footrest assembly further comprises a fastener;
when the second part is connected to the first part at the first position, the fastener is received in the first and third apertures; and
when the first part is connected to the second part at the second position, the fastener is received in the second and third apertures.

18. The straddle-seat vehicle of claim 17, wherein:
the at least two positions includes three positions,
the first part defines a fourth aperture, and the second part can be positioned at a third position along a length of the first part, and
when the second part is connected to the first part at the third position, the fastener is received in the third and fourth apertures.

19. The straddle-seat vehicle of claim 13, wherein:
the first part has at least a first engaging member and a second engaging member;
the second part has a third engaging member engageable to one of the first and second engaging members;
when the second part is connected to the first part at the first position, the third engaging member engages the first engaging member; and
when the second part is connected to the first part at the second position, the third engaging member engages the second engaging member.

20. The straddle-seat vehicle of claim 13, wherein the first part includes a beam-like portion extending along the length of the first part and outwardly from the frame.

21. The straddle-seat vehicle of claim 20, wherein the second part defines a receiving aperture configured to at least partially receive the beam-like portion.

22. The straddle-seat vehicle of claim 20 or 21, wherein the second part has a second connecting portion configured to engage with the beam-like portion.

23. An outer part for a footrest assembly, the outer part being selectively connectable to an inner part connected to a frame of a vehicle, the outer part comprising:
a footrest portion defined on a top surface of the outer part;
a connecting portion defined on an inner side of the outer part, the connecting portion defining an aperture configured to receive a fastener therethrough and the connecting portion being selectively connectable to the inner part at at least two positions along a length of the inner part.

24. The outer part of claim 23, wherein the outer part defines a receiving aperture configured to receive at least a portion of the inner part.

25. The outer part of claim 23, wherein the outer part defines an engaging member engageable with at least one engaging member of the inner part.

26. The outer part of claim 23, wherein the footrest portion has traction enhancing members extending from the top surface of the outer part.

27. The outer part of any one of claims 23 to 26, wherein the footrest portion has a side member disposed on a second lateral side of the outer part and extending upwardly from the top surface.
